(19) United States
(12) Patent Application Publication
(10) Pub. No.: US 2015/0169212 A1
(43) Pub. Date: Jun. 18, 2015

(54) Character Recognition Using a Hybrid Text Display

(71) Applicants: Lawrence Chang, Foster City, CA (US); Rui Ueyama, Mountain View, CA (US)

(72) Inventors: Lawrence Chang, Foster City, CA (US); Rui Ueyama, Mountain View, CA (US)

(73) Assignee: Google Inc., Mountain View, CA (US)

(21) Appl. No.: 13/619,936

(22) Filed: Sep. 14, 2012

Related U.S. Application Data
(60) Provisional application No. 61/570,666, filed on Dec. 14, 2011.

(51) Int. Cl. G06F 3/0488; G06F 17/30; G06T 11/60; G06F 3/0484

(52) U.S. Cl. CPC G06F 3/04883; G06F 3/04847; G06F 17/30011; G06T 11/60

(57) ABSTRACT

A character recognition application is disclosed for receiving touch gesture input and displaying scaled representations of the input. A user is given the ability to input textual content using a touch sensor. The character recognition application may receive the textual content and identify related computer generated characters. The character recognition application may display scaled representations of the textual content together with computer generated characters in a predefined area of a display screen.

This application claims priority to U.S. Provisional Application No. 61/570,666, filed Dec. 14, 2011, which is incorporated herein by reference in its entirety.

### BACKGROUND

The present disclosure relates generally to a hybrid text display, and more particularly, to displaying both handwritten textual content and computer generated characters in the same region of a display screen. Receiving textual input on a user device such as a smartphone includes using, for example, mechanical keyboards and touchscreen input. Some user device touchscreens are capable of receiving handwriting input.

### SUMMARY

Methods, systems, and computer-readable media are provided for implementing a character recognition application used to display textual content on a mobile device display screen. In some implementations, the character recognition application receives handwritten input from a user and displays a rescaled representation of the handwritten input. In some implementations, the character recognition application replaces the rescaled representation with a corresponding computer-generated character.

In general, one aspect of the subject matter described in this specification can be implemented in computer-implemented methods that include the actions of receiving touch gesture input indicative of at least one textual character, generating a representation of the at least one textual character based on the gesture input, scaling the representation according to one or more predetermined dimensions to generate a scaled representation, displaying the scaled representation in a designated portion of a display screen, communicating data based on the representation to a remote server, receiving from the remote server at least one computer generated character based on the data, and displaying the at least one computer generated character in place of the scaled representation. Other implementations of this aspect include corresponding systems, apparatus, and computer programs, configured to perform the actions of the methods, encoded on computer storage devices.

These and other implementations can each include one or more of the following features. In some implementations, displaying the scaled representation in the designated portion of the display comprises displaying the scaled representation in a text box. In some implementations, the dimensions of the scaled representation are based at least in part on the dimensions of the text box. In some implementations, receiving touch gesture input indicative of the at least one textual character comprises detecting using a touch sensor a user gesture defining a handwritten glyph. In some implementations, detecting the user gesture comprises detecting the user gesture within a touch sensitive area of the display, regardless of whether content is displayed in the touch sensitive area. Some implementations further comprise displaying, using one or more computers, a trace on the display corresponding to where the user touches the display when drawing the handwritten glyph as the user draws it on the display. In some implementations, the scaled representation is a first scaled representation and wherein the at least one computer generated character is displayed in the designated portion of the display simultaneously with a second scaled representation. In some implementations, the designated portion of the display comprises a search box, the method further comprising automatically updating, in real time, a search query based on the at least one computer generated character displayed within the search box. Some implementations further comprise hiding and displaying, using one or more computers, a text insertion indicator based at least in part on a state of the user device.

### BRIEF DESCRIPTION OF THE FIGURES

The above and other features of the present disclosure, its nature and various advantages will be more apparent upon consideration of the following detailed description, taken in conjunction with the accompanying drawings in which:

FIG. 1 shows an illustrative system for implementing a character recognition application in accordance with some implementations of the present disclosure;

FIG. 2 is a block diagram of a user device in accordance with some implementations of the present disclosure;

FIG. 3 is a flow diagram showing illustrative steps for implementation of a character recognition application in accordance with some implementations of the present disclosure;

FIG. 4 is an illustrative example of a character recognition application interface for recognizing and displaying text in accordance with some implementations of the present disclosure;

FIG. 5 is a further illustrative example of a character recognition application interface for recognizing and displaying text in accordance with some implementations of the present disclosure;

FIG. 6 is a further illustrative example of a character recognition application interface for recognizing and displaying text in accordance with some implementations of the present disclosure;

FIG. 7 is a further illustrative example of a character recognition application interface for recognizing and displaying text in accordance with some implementations of the present disclosure;

FIG. 8 is a further illustrative example of a character recognition application interface for recognizing and displaying text in accordance with some implementations of the present disclosure;

FIG. 9 is a further illustrative example of a character recognition application interface for recognizing and displaying text in accordance with some implementations of the present disclosure;

FIG. 10 is a further illustrative example of a character recognition application interface for recognizing and displaying text in accordance with some implementations of the present disclosure;

FIG. 11 is an illustrative example of a character recognition application interface for rescaling the representations of handwritten glyphs, in accordance with some implementations of the present disclosure;

FIG. 12 is an illustrative smartphone device on which a character recognition application may be implemented in accordance with some implementations of the present disclosure; and

FIG. 13 is an illustrative example of a character recognition application interface for recognizing punctuation and control characters in accordance with some implementations of the present disclosure.

### DETAILED DESCRIPTION OF THE FIGURES

The present disclosure is directed toward systems and methods for displaying textual content as both scaled representations of handwritten glyphs and computer generated characters together in a substantially similar location of a display screen of a user device. A substantially similar location may include, for example, the area within a text box, the same line in a block of text, any other suitable location defining a particular region of the display screen or of another, larger, region of the display screen, or any combination thereof.

The term glyph, as used herein, shall refer to a concrete representation of textual content such as a character, number, letter, symbol, diacritic, ligature, ideogram, pictogram, any other suitable textual content, or any combination thereof. The term grapheme, as used herein, shall refer to an abstract representation of an element of writing. For example, a handwritten block letter “a,” a handwritten cursive “a” and a computer generated character “a” are three glyphs related to the abstract lowercase “a” grapheme. The term computer generated character, as used herein, shall refer to characters generated by processing equipment, e.g., processing equipment of a smartphone, tablet, laptop, desktop.

The present disclosure is written in the context of a character recognition application. The character recognition application may be any suitable software, hardware, or both that implements the features disclosed in the present disclosure. The character recognition application may itself be implemented as a single module in one device, e.g., a user device or a server device, or as a distributed application implemented across multiple devices, e.g., a user device and a server. The character recognition application may include multiple modules that may be implemented in a single device or across multiple devices or platforms.

In some implementations, the character recognition application may receive one or more handwritten glyphs using, for example, a touchscreen of a user device. The character recognition application may generate a representation of the handwritten glyph. In some implementations, the character recognition application may rotate and scale the representation, and display the scaled representation in a predetermined area of a display screen. The character recognition application may use processing equipment to recognize the grapheme associated with the handwritten glyph and provide a computer generated character related to the same grapheme. In some implementations, the character recognition application may replace the scaled representations with the computer generated characters. In some implementations, the character recognition application may display both handwritten glyphs and computer generated characters in the same area of the display screen, for example, in a search box.

In some implementations, the character recognition application may receive textual input to a sensor in the form of handwritten glyphs, e.g., in a form similar to writing with pen on paper. The term textual input, as used herein, shall refer to content that may be used in a search query, text document, e-mail, web browser, phone dialer, any other suitable application for textual input, or any combination thereof. The character recognition application may be implemented on a user device such as, for example, a smartphone, tablet, laptop, desktop computer, or other suitable device. In some implementations, the sensor may include a touchscreen, a touchpad, an electronic drawing tablet, any other suitable sensor, or any combination thereof.

In some implementations, the character recognition application may receive handwritten glyphs at a rate faster than the rate that the character recognition application can recognize the representations of the glyphs and provide computer generated characters. The character recognition application may display the scaled representations of the handwritten glyphs as one or more placeholders before corresponding computer generated characters are identified. In some implementations, the placeholder may be an icon or other suitable display object when a scaled representation of the glyph is not desired, not available, or any combination thereof. Placeholders may aid the user in inputting textual content as the placeholder may provide visual feedback related to prior input. For example, if the character recognition application receives a word letter-by-letter sequentially, the scaled representations of the handwritten glyphs may indicate previously received letters.

In some implementations, the character recognition application may communicate representations of the handwritten glyphs to a remote server for processing. For example, the character recognition application may require processing equipment to recognize the representations of handwritten glyphs and provide computer generated characters that exceeds the capability of processing equipment local to the user device.

In some implementations, the character recognition application may receive handwritten glyphs from the user while awaiting a response from the remote server regarding previously communicated representations. In some implementations, the character recognition application may dynamically adjust the extent to which remote processing equipment is employed based on network speed, network availability, remote server access, remote server capability, remote server availability, local processing equipment capability, user preferences, other suitable criteria, or any combination thereof.

In some implementations, the character recognition application may receive a handwritten glyph in a first area of a display screen. The scaled representation of the glyph may be displayed in, for example, a relatively smaller second area of the display screen. In some implementations, the first area may include substantially all of the display screen, e.g., while content is being displayed in the display screen. The second area may include a predefined area such as a text box.

The character recognition application may use one or more processing steps to rotate the representation, scale the representation, or any combination thereof. For example, the character recognition application may scale the glyph such that a predefined proportion of the glyph is contained by one or more predefined boundaries. The character recognition application may rotate the scaled representation such that it is substantially aligned with the display screen of the user device.

In some implementations, the character recognition application may be implemented to allow certain user device functions to be maintained when character recognition is activated. For example, the character recognition application may interpret a single tap on a touchscreen as being distinct from input of textual content on the touchscreen. In a further example, the character recognition application may recognize a zoom gesture, a scroll gesture, or other predefined gesture as not relating to the input of textual content. In some implementations, a predefined gesture may be recognized as punctuation, e.g., a horizontal swipe may be recognized as a space character).

In some implementations, the character recognition application may recognize the representations of handwritten glyphs and provide computer generated characters asynchronously with respect to the order in which the glyphs were received by the user device. In some implementations, scaled representations of glyphs do not precede computer generated characters. For example, if handwritten glyphs representing “a b c d” are received by the character recognition application in that order, and computer generated characters are received from the processing equipment in the order “a b d c,” the character recognition application may replace the handwritten glyphs “a” and “b” with computer generated characters immediately upon receipt from the processing equipment, hold computer generated “d” in memory, display computer generated “c” immediately upon receipt, and finally display computer generated “d” from memory. In some implementations, the character recognition application may store in memory or delay displaying information received from processing equipment to improve the speed or performance of the user device. In some implementations, computer generated characters may be displayed in the order they are received from a remote server, as complete words, in any other suitable arrangement, or any combination thereof. In some implementations, the character recognition application displays or hides a text insertion indicator, e.g., a cursor, depending on the state of the input. For example, the system may display a blinking cursor when the rightmost character is a computer generated characters, and may hide the cursor when the rightmost character is a representation of a handwritten glyph.

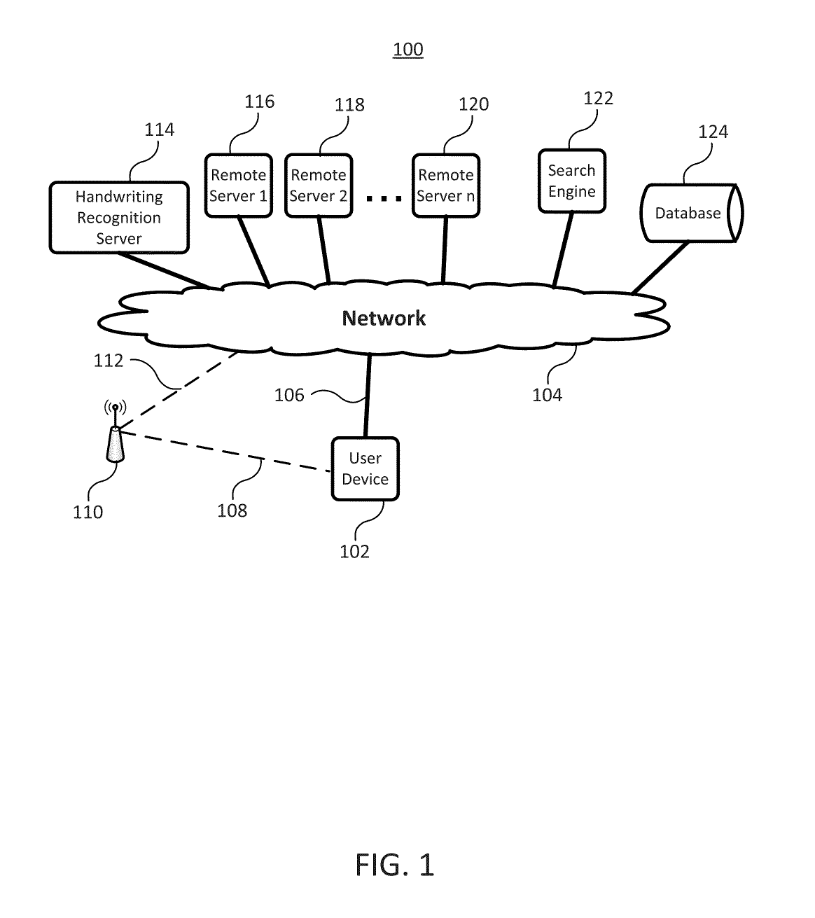

The following description and accompanying FIGS. 1-13 provide additional details and features of some implementations of the character recognition application and its underlying system.

FIG. 1 shows illustrative system 100 for implementing a character recognition application in accordance with some implementations of the present disclosure. System 100 may include one or more user devices 102. In some implementations, user device 102 may include a smartphone, tablet computer, desktop computer, laptop computer, personal digital assistant, portable audio player, portable video player, mobile gaming device, any other suitable user device, or any combination thereof.

User device 102 may be coupled to network 104 directly through connection 106, through wireless repeater 110, by any other suitable coupling to network 104, or any combination thereof. Network 104 may include the Internet, a dispersed network of computers and servers, a local network, a public intranet, a private intranet, any other suitable coupled computing systems, or any combination thereof.

In some implementations, user device 102 may be coupled to network 104 by wired connection 106. Connection 106 may include, for example, Ethernet hardware, coaxial cable hardware, DSL hardware, T-1 hardware, fiber optic hardware, analog phone line hardware, any other suitable wired hardware capable of communicating, or any combination thereof. Connection 106 may include transmission techniques including TCP/IP transmission techniques, IEEE 802 transmission techniques, Ethernet transmission techniques, DSL transmission techniques, fiber optic transmission techniques, ITU-T transmission techniques, any other suitable transmission techniques, or any combination thereof.

In some implementations, user device 102 may be wirelessly coupled to network 104 by wireless connection 108. In some implementations, wireless repeater 110 may receive transmitted information from user device 102 using wireless connection 108, and may communicate the information with network 104 by connection 112. Wireless repeater 110 may receive information from network 104 using connection 112, and may communicate the information with user device 102 using wireless connection 108. In some implementations, wireless connection 108 may include cellular phone transmission techniques, code division multiple access, also referred to as CDMA, transmission techniques, global system for mobile communications, also referred to as GSM, transmission techniques, general packet radio service, also referred to as GPRS, transmission techniques, satellite transmission techniques, infrared transmission techniques, Bluetooth transmission techniques, Wi-Fi transmission techniques, WiMax transmission techniques, any other suitable transmission techniques, or any combination thereof.

In some implementations, connection 112 may include Ethernet hardware, coaxial cable hardware, DSL hardware, T-1 hardware, fiber optic hardware, analog phone line hardware, wireless hardware, any other suitable hardware capable of communicating, or any combination thereof. Connection 112 may include, for example, wired transmission techniques including TCP/IP transmission techniques, IEEE 802 transmission techniques, Ethernet transmission techniques, DSL transmission techniques, fiber optic transmission techniques, ITU-T transmission techniques, any other suitable transmission techniques, or any combination thereof. Connection 112 may include may include wireless transmission techniques including cellular phone transmission techniques, code division multiple access, also referred to as CDMA, transmission techniques, global system for mobile communications, also referred to as GSM, transmission techniques, general packet radio service, also referred to as GPRS, transmission techniques, satellite transmission techniques, infrared transmission techniques, Bluetooth transmission techniques, Wi-Fi transmission techniques, WiMax transmission techniques, any other suitable wireless transmission technique, or any combination thereof.

Wireless repeater 110 may include any number of cellular phone transceivers, network routers, network switches, communication satellites, other devices for communicating information from user device 102 to network 104, or any combination thereof. It will be understood that the arrangement of connection 106, wireless connection 108 and connection 112 is merely illustrative, and that system 100 may include any suitable number of any suitable devices coupling user device 102 to network 104.

In some implementations, system 100 may include handwriting recognition server 114 coupled to network 104. Handwriting recognition server 114 may be configured to identify graphemes associated with handwritten glyphs, with other textual content, or any combination thereof. Handwriting recognition server 114 may be configured to provide computer generated characters related to the identified graphemes. System 100 may include any suitable number of remote servers 116, 118, and 120, coupled to network 104. One or more search engine servers 122 may be coupled to the network 104. One or more database servers 124 may be coupled to network 104. It will be understood that one or more functions of handwriting recognition server 114 may be implemented at least in part in user device 102, remote servers 116, 118, and 120, search engine server 122, database server 124, any other suitable equipment, or any combination thereof.

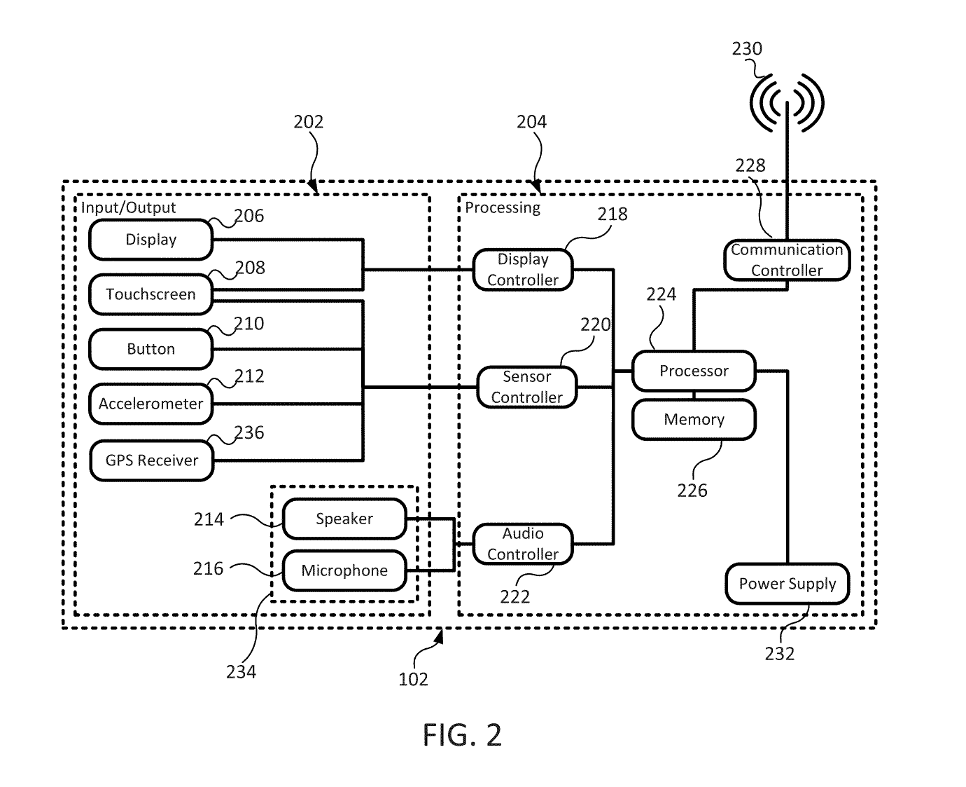

FIG. 2 is a block diagram of user device 102 of FIG. 1 in accordance with some implementations of the present disclosure. User device 102 may include input/output equipment 202 and processing equipment 204. Input/output equipment 202 may include display 206, touchscreen 208, button 210, accelerometer 212, global positioning system, also referred to as GPS, receiver 236, and audio equipment 234 including speaker 214 and microphone 216.

In some implementations, display 206 may include a liquid crystal display, light emitting diode display, organic light emitting diode display, amorphous organic light emitting diode display, plasma display, cathode ray tube display, projector display, any other suitable type of display capable of displaying content, or any combination thereof. Display 206 may be controlled by display controller 218 which may be included in processing equipment 204, as shown, processor 224, processing equipment internal to display 206, any other suitable controlling equipment, or by any combination thereof.

Touchscreen 208 may include a sensor capable of sensing pressure input, capacitance input, resistance input, piezoelectric input, optical input, acoustic input, sensing any other suitable input, or any combination thereof. In some implementations, touchscreen 208 may be capable of receiving touch-based gestures. A received gesture may include information relating to one or more locations on the surface of touchscreen 208, pressure of the gesture, speed of the gesture, duration of the gesture, direction of paths traced on the surface of touchscreen 208 by the gesture, motion of the device in relation to the gesture, other suitable information regarding a gesture, or any combination thereof. In some implementations, touchscreen 208 may be optically transparent and located above or below display 206. Touchscreen 208 may be coupled to and controlled by display controller 218, sensor controller 220, processor 224, any other suitable controller, or any combination thereof.

In some embodiments, a gesture received by touchscreen 208 may cause a corresponding display element to be displayed substantially concurrently by display 206. For example, when the gesture is a movement of a finger or stylus along the surface of touchscreen 208, the character recognition application may cause a visible line of any suitable thickness, color, or pattern indicating the path of the gesture to be displayed on display 206.

Button 210 may include one or more electromechanical push-button mechanisms, slide mechanisms, switch mechanisms, rocker mechanisms, toggle mechanisms, any other suitable mechanisms, or any combination thereof. Button 210 may be included as a predefined region of touchscreen 208, e.g., one or more softkeys. Button 210 may be included as a region of touchscreen 208 defined by the character recognition application and indicated by display 206. Activation of button 210 may send a signal to sensor controller 220, processor 224, display controller 220, any other suitable processing equipment, or any combination thereof. Activation of button 210 may include receiving from the user a pushing gesture, sliding gesture, touching gesture, pressing gesture, time-based gesture, e.g., based on a duration of a push, any other suitable gesture, or any combination thereof.

Accelerometer 212 may be capable of receiving information about the motion characteristics, acceleration characteristics, orientation characteristics, inclination characteristics and other suitable characteristics, or any combination thereof, of user device 102. Accelerometer 212 may be a mechanical device, microelectromechanical, also referred to as MEMS, device, nanoelectromechanical, also referred to as NEMS, device, solid state device, any other suitable sensing device, or any combination thereof. In some implementations, accelerometer 212 may be a 3-axis piezoelectric microelectromechanical integrated circuit which is configured to sense acceleration, orientation, or other suitable characteristics by sensing a change in the capacitance of an internal structure. Accelerometer 212 may be coupled to touchscreen 208, and information received by accelerometer 212 with respect to a gesture may be used at least in part by processing equipment 204 to interpret the gesture.

Global positioning system, also referred to as GPS, receiver 236 may be capable of receiving signals from one or more global positioning satellites. In some implementations, GPS receiver 236 may receive information from one or more satellites orbiting the earth, the information including time, orbit, other information related to the satellite, or any combination thereof. The information may be used to calculate the location of user device 102 on the surface of the earth. GPS receiver 236 may include a barometer, not shown, to improve the accuracy of the location calculation. GPS receiver 236 may receive information from one or more wired or wireless communication sources regarding the location of user device 102. For example, the identity and location of nearby cellular phone towers may be used in place of, or in addition to, GPS data to determine the location of user device 102.

Audio equipment 234 may include sensors and processing equipment for receiving and transmitting information using pressure, e.g., acoustic, waves. Speaker 214 may include equipment to produce acoustic waves in response to a signal. In some implementations, speaker 214 may include an electroacoustic transducer, which may include an electromagnet coupled to a diaphragm to produce acoustic waves in response to an electrical signal. Microphone 216 may include electroacoustic equipment to convert acoustic signals into electrical signals. In some implementations, a condenser-type microphone may use a diaphragm as a portion of a capacitor such that acoustic waves induce a capacitance change in the device, which may be used as an input signal by user device 102.

Speaker 214 and microphone 216 may be included in user device 102, or may be remote devices coupled to user device 102 by any suitable wired or wireless connection, or any combination thereof.

Speaker 214 and microphone 216 of audio equipment 234 may be coupled to audio controller 222 in processing equipment 204. Audio controller 222 may send and receive signals from audio equipment 234 and perform pre-processing and filtering steps before communicating signals related to the input signals to processor 224. Speaker 214 and microphone 216 may be coupled directly to processor 224. Connections from audio equipment 234 to processing equipment 204 may be wired, wireless, other suitable arrangements for communicating information, or any combination thereof.

Processing equipment 204 of user device 102 may include display controller 218, sensor controller 220, audio controller 222, processor 224, memory 226, communication controller 228, and power supply 232.

Processor 224 may include circuitry to interpret signals input to user device 102 from, for example, touchscreen 208, microphone 216, any other suitable input, or any combination thereof. Processor 224 may include circuitry to control the output to display 206, speaker 214, any other suitable output, or any combination thereof. Processor 224 may include circuitry to carry out instructions of a computer program. In some implementations, processor 224 may be an integrated circuit based substantially on transistors, capable of carrying out the instructions of a computer program and include a plurality of inputs and outputs.

Processor 224 may be coupled to memory 226. Memory 226 may include random access memory, also referred to as RAM, flash memory, programmable read only memory, also referred to as PROM, erasable programmable read only memory, also referred to as EPROM, magnetic hard disk drives, magnetic tape cassettes, magnetic floppy disks optical CD-ROM discs, CD-R discs, CD-RW discs, DVD discs, DVD+R discs, DVD−R discs, any other suitable storage medium, or any combination thereof.

The functions of display controller 218, sensor controller 220, and audio controller 222, as described above, may be fully or partially implemented as discrete components in user device 102, fully or partially integrated into processor 224, combined in part or in full into one or more combined control units, or any combination thereof.

Communication interface 228 may be coupled to processor 224 of user device 102. In some implementations, communication controller 228 may communicate radio frequency signals using antenna 230. In some implementations, communication controller 228 may communicate signals using a wired connection, not shown. Wired and wireless communications communicated by communication interface 228 may use amplitude modulation, frequency modulation, bitstream, code division multiple access, also referred to as CDMA, global system for mobile communications, also referred to as GSM, general packet radio service, also referred to as GPRS, Bluetooth, Wi-Fi, WiMax, any other suitable communication protocol, or any combination thereof. The circuitry of communication controller 228 may be fully or partially implemented as a discrete component of user device 102, may be fully or partially included in processor 224, or any combination thereof.

Power supply 232 may be coupled to processor 224 and to other components of user device 102. Power supply 232 may include a lithium-polymer battery, lithium-ion battery, NiMH battery, alkaline battery, lead-acid battery, fuel cell, solar panel, thermoelectric generator, any other suitable power source, or any combination thereof. Power supply 232 may include a hard wired connection to an electrical power source, and may include electrical equipment to convert the voltage, frequency, and phase of the electrical power source input to suitable power for user device 102. In some implementations, power supply 232 may include a wall outlet that may provide 120 volts, 60 Hz alternating current, also referred to as AC. Circuitry, which may include transformers, resistors, inductors, capacitors, transistors, and other suitable electronic components included in power supply 232, may convert the 120V AC from a wall outlet power to 5 volts at 0 Hz, also referred to as direct current. In some implementations, power supply 232 may include a lithium-ion battery that may include a lithium metal oxide-based cathode and graphite-based anode that may supply 3.7V to the components of user device 102. Power supply 232 may be fully or partially integrated into user device 102, may function as a stand-alone device, or any combination thereof. Power supply 232 may power user device 102 directly, may power user device 102 by charging a battery, provide power by any other suitable way, or any combination thereof.

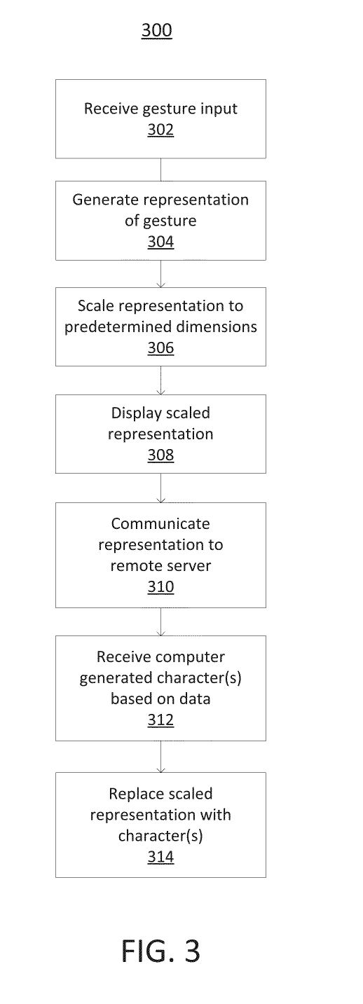

FIG. 3 is flow diagram 300 showing illustrative steps for implementation of a character recognition application in accordance with some implementations of the present disclosure. In step 302, the character recognition application may receive a gesture input. The gesture input may be received using touchscreen 208 of FIG. 2, a mouse, trackball, keyboard, pointing stick, joystick, touchpad, other suitable input device capable of receiving a gesture, or any combination thereof. In some implementations, the character recognition application may use a predefined portion of the display screen as the glyph detection area. In some implementations, the character recognition application may use the entire touchscreen as the glyph detection area.

In some implementations, a gesture received by the touchscreen may cause a corresponding display element to be displayed substantially concurrently by the display. For example, when the gesture is a movement of a finger or stylus along the surface of the touchscreen, e.g, touchscreen 208 of FIG. 2, the character recognition application may cause a visible line of any suitable thickness, color, or pattern indicating the path of the gesture to be displayed on the display, e.g., display 206 of FIG. 2.

In step 304, the character recognition application may generate a representation of the gesture. For example, if a gesture is received using a touchscreen, the character recognition application may generate a bitmap image wherein the locations on the screen that have been indicated by the gesture are recorded in raster coordinates. In some implementations, the gesture information may be represented as vector information. A bitmap or vector image representation of the gesture may be compressed using any suitable compression scheme such as JPEG, TIFF, GIF, PNG, RAW, SVG, other suitable formats, or any combination thereof. In some implementations, the representation of the gesture may contain information about how the gesture was received, for example, the speed of the gesture, duration of the gesture, pressure of the gesture, direction of the gesture, other suitable characteristics, or any combination thereof.

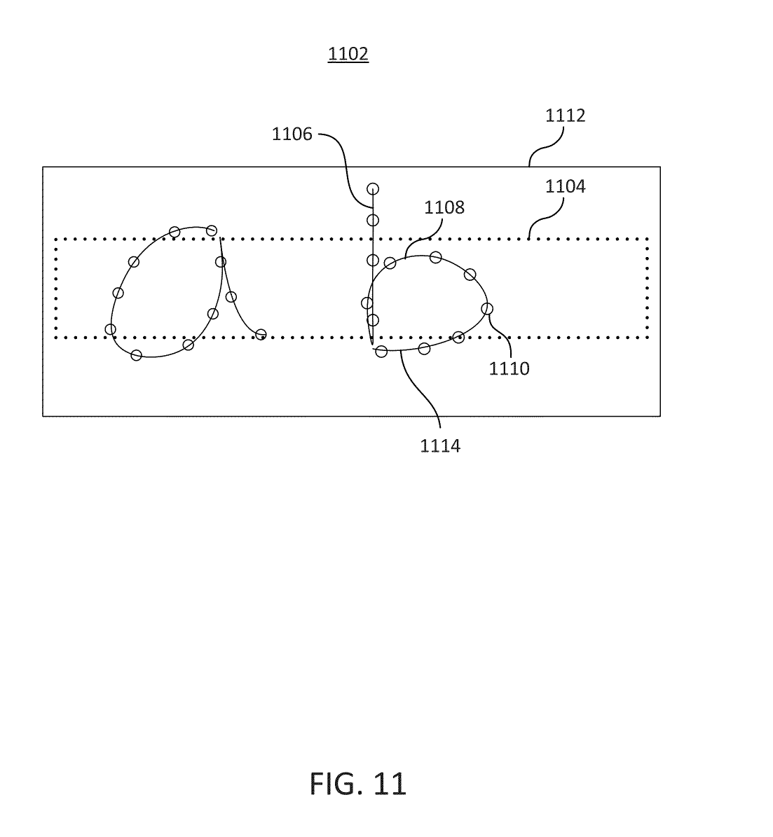

In step 306, the character recognition application may scale the representation to one or more predetermined dimensions. For example, the character recognition application may scale the representation as illustrated in FIG. 11, described below. This may include scaling or adjusting the dimensions of the representation. In some implementations, the dimensions of the scaled representation may be based at least in part on the dimensions of the text box or other display area where the scaled representations are displayed. For example, the character recognition application may scale the representation to fit the dimensions of a smaller region of the display screen relative to the region where the gesture was originally received. The smaller region may be a separate and distinct region from the region where the gesture was originally received. In some implementations, the smaller region may overlap either partially or entirely with the region in which the gesture was originally received. In some implementations, scaling may involve changing the dimensions of the representation to fit a larger region of the display screen. In a further example, the character recognition application may scale a raster image by reducing the resolution of the raster, by changing the display size of the individual pixels described the raster, by any other suitable technique, or any combination thereof. The character recognition application may scale representations stored as a vector by changing the properties used in drawing the image on the display screen. The character recognition application may rotate representations of gestures with respect to the display screen. For example, the character recognition application may rotate representations such that the baseline of a handwritten glyph is substantially parallel with the bottom edge of the display screen.

In some implementations, the character recognition application may shift the scaled representation vertically, horizontally, or any combination thereof, such that the representations are substantially aligned. For example, the character recognition application may shift scaled representations vertically such that the baseline of a first scaled representation aligns with the baseline of a second scaled representation. In another example, the character recognition application may shift characters such that the horizontal midline of a first scaled representation aligns with the horizontal midline of a second scaled representation. In some implementations, the character recognition application may shift character horizontally such that there is a predefined or dynamically adjusted amount of space between the scaled representations or computer generated characters.

In step 308, the character recognition application may display the scaled representation on the display screen. In some implementations, the character recognition application may use the scaled representations as placeholders while identifying related computer generated characters. In some implementations, the character recognition application may display scaled representations in a predefined display area, for example, a search box, text box, email document, other region containing textual input, or any combination thereof.

In some implementations, the predefined display area may overlap with the glyph detection area. In some implementations, the predefined display area may be separate from the glyph detection area. For example, the character recognition application may receive handwritten glyphs using the entire touchscreen, and it may display scaled representations in a search query box displayed at the top of the display screen. It will be understood that the character recognition application may include a glyph detection area and a predefined display area of any suitable combination of size, shape, and arrangement.

In step 310, the character recognition application may communicate the representation of the gesture to a remote server. The character recognition application may communicate with a handwriting recognition server such as server 114 of FIG. 1, remote servers 116, 118, and 120 of FIG. 1, search engine server 122 of FIG. 1, database server 124 of FIG. 1, any other suitable server, or any combination thereof. In some implementations, the processing steps of the handwriting recognition server may be carried out by processing equipment local to the user device, by any number of remote servers, or by any combination thereof. In some implementations, the character recognition application may communicate representations with one or more servers based on the servers' location, availability, speed, ownership, other characteristics, or any combination thereof. It will be understood that that the character recognition application may perform step 310 using any suitable local processing equipment, remote processing equipment, any other suitable equipment, or any combination thereof.

In step 312, the character recognition application may receive computer generated characters from one or more remote servers. The character recognition application may receive computer generated characters related to the representations of the gestures communicated in step 310. For example, if a character recognition application communicates a representation of a gesture including a handwritten glyph of the letter “a” to a remote server, the character recognition application may receive a computer generated character “a” from the remote server. The character recognition application may receive other computer generated characters that may be indicated by the representation of the gesture. The character recognition application may receive strings of letters, words, multiple words, any other textual information related to the representation of the gesture, or any combination thereof. In some implementations, the character recognition application may receive other contextual information from the remote server such as, for example, time-stamps. The character recognition application may receive punctuation characters, e.g., a space, a comma, a period, exclamation point, question mark, quotation mark, slash, or other punctuation character, in response to predefined gestures.

In some implementations, the character recognition application may receive individual computer generated characters from a remote server. In some implementations, the character recognition application may receive words, phrases, sentences, or other suitable segments of textual content from the remote server. In some implementations, the remote server may parse the textual content and perform a spell-check, grammar-check, language identification, pattern recognition, any other suitable processing, or any combination thereof, such that the desired word may be identified without an exact recognition of handwritten glyphs. In some implementations, the character recognition application may receive one or more complete words from the remote server related to a concatenation of previously processed characters. For example, the character recognition application may receive the computer generated characters “t, e, l, e, p, h, e, n, e” in response to representation of gestures that were intended by the user to spell “telephone.” The incorrect recognition of the third “e” may be due to an incorrect spelling, an incorrect recognition of the handwritten glyph, or both. The character recognition application may receive the complete word “telephone” from the remote server following a spell-check. In some implementations, the character recognition application may display the characters as they are received and replace the misspelled word with the correctly spelled word following a spell-check. In some implementations, the character recognition application may wait to replace scaled characters until complete, spell-checked words are received. In some implementations, the character recognition application may display a list of possible words to the user for further refinement, e.g., allowing the user to select one or more words from the list. In some implementations, the character recognition application may use other possible identifications of handwritten glyphs to generate alternate word choices. For example, if the character recognition receives the handwritten glyphs “p, o, t” where the handwritten “o” is inconclusively determined to represent the grapheme “o,” “a,” or “e,” the character recognition application may return the words “pot,” “pat,” and “pet” to the user. In some implementations, the character recognition application may provide one or more predictive word choices to the user before all of the characters of the word have been received. In some implementations, the character recognition application may execute the spell-check and other parsing of the content on processing equipment local to the user device.

In step 314, the character recognition application may replace the scaled representation of the gesture with computer generated characters related to the same grapheme. In some implementations, replacing the scaled representation may include removing the scaled representation from a location on the display screen and displaying the computer generated character in the same location of the display screen, in a different location of the display screen, in any other suitable location, or any combination thereof. For example, the character recognition application may display one or more scaled representations in a text box, and may replace the scaled representations with computer generated characters provided by handwriting recognition server 114 of FIG. 1. In some implementations, both the scaled representation and the computer generated characters may be displayed on the display screen at the same time. For example, the scaled representations may be displayed directly above or below their related computer generated characters.

The character recognition application may replace scaled representations with computer generated characters simultaneously or sequentially, e.g., one or more at a time. As described above, the character recognition application may receive computer generated characters relating to representations of gestures in an order different than the order in which they were communicated to the remote server. In some implementations, the character recognition application may replace scaled representations with computer generated characters as the computer generated characters are received from the remote server. In some implementations, the character recognition application may hold computer generated characters in a queue, e.g., store in a data buffer, before displaying them. In some implementations, the character recognition application may replace a particular scaled representation with its respective computer generated character only when all preceding representations have been replaced with computer generated characters. In some implementations, the character recognition application will replace scaled representations of complete words, phrases, sentences, or other suitable segments of textual content when they have been received in full. In some implementations, the character recognition application may identify word separations using space characters, symbols, other suitable characters, or any combination.

It will be understood that the order of steps of flow diagram 300 is merely illustrative and other suitable arrangements may be possible in accordance with some implementations of the present disclosure. For example, step 310, communicating the representation to the server, may precede step 308, displaying the scaled representation.

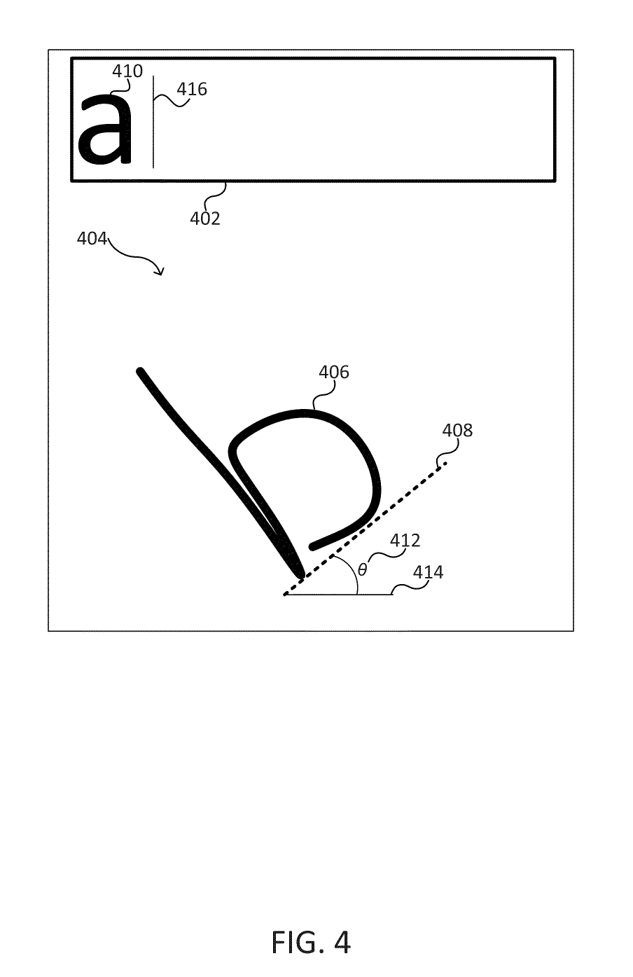

It will be understood that the arrangement shown below in FIGS. 4-13 is merely illustrative. It will be understood that the character recognition application may use any suitable arrangement of display regions and handwritten glyph detection areas. For example, the two regions may at least in part occupy the same area of a display screen. The particular grouping of characters and processing sequence is also merely illustrative any the character recognition application may carry out these steps in any suitable arrangement and order.

It will be understood that the characters illustrated may represent any number of glyphs or other textual content including letters, numbers, punctuation, diacritics, logograms, pictograms, ideograms, ligatures, syllables, strings of characters, words, sentences, other suitable input, or any combination thereof. The character recognition application may recognize characters from any alphabet, e.g., Roman, Cyrillic, or Greek, language, e.g., Chinese, or Japanese, or writing system, e.g., upper case Latin, lower case Latin, cursive, or block letters. The character recognition application may recognize characters from more than one language, alphabet, or writing system at the same time. In some implementations, an alphabet, language, or writing system may be predefined by user preferences. For example, character recognition application may be set to receive Greek characters, aiding differentiation between a roman “a” and Greek “alpha.” In some implementations, the character recognition may automatically identify the language, alphabet, or writing system to which a character may belong. For example, the character recognition application may dynamically reconfigure to recognize roman letters, followed by Arabic numerals, followed by Japanese characters. In some implementations where multiple writing systems exist for the same language, for example, Japanese Kanji, Japanese Kana, and Latin alphabet transliterations of Japanese words such as Romaji, the character recognition application may receive and recognize any suitable combination of input gestures and provide related computer generated characters.

FIG. 4 is an illustrative example of a character recognition application interface for recognizing and displaying text in accordance with some implementations of the present disclosure. In some implementations, the character recognition application may include a display region 402 and handwritten glyph detection area 404.

In the implementation illustrated in FIG. 4, a computer generated character “a” 410 is displayed in display region 402. The character recognition application may have information related to computer generated character “a” 410 from a previously entered handwritten glyph, from a character entered using a keyboard, by any other suitable input method, or any combination thereof. The character recognition application may receive handwritten glyph “b” 406 in handwritten glyph detection area 404. For example, the character recognition application may receive input using a touchscreen from the finger or stylus of a user tracing the path indicated by handwritten glyph “b” 406, as described in step 302 of FIG. 3. The character recognition application may generate a representation of the traced path as described in step 304 of FIG. 3. For example, the character recognition application may generate bitmap image data containing information related to the locations on a touchscreen indicated by handwritten glyph “b” 406. The character recognition application may communicate the representation of handwritten glyph “b” 406 with the remote server, e.g., handwriting recognition server 114 of FIG. 1, as described in step 310 of FIG. 3. The character recognition application may display a representation of handwritten glyph “b” 406 on the display screen as it is received. For example, a line of any suitable color, thickness, and pattern following the trace of handwritten glyph “b” 406 may be displayed in the handwritten glyph detection area 404 by a display screen that is substantially aligned with the touchscreen.

In some implementations, the character recognition application may receive a handwritten glyph such as handwritten glyph “b” 406 at an angle with respect to the display screen. The character recognition application may identify baseline 408 of the character, shown as a dotted line in FIG. 4. The character recognition application may or may not display baseline 408 in the display screen. The character recognition application may rotate the handwritten glyph such that baseline 408 is substantially parallel to the bottom of the display screen. For example, the glyph may be rotated such that angle θ 412 formed between reference line 414 and baseline 408 is substantially similar to 0 degrees.

In some implementations, text insertion indicator 416 is displayed to indicate to the user where the next character will be entered. In some implementations, the character recognition application may receive input from the user indicating a different text insertion location, for example, where text is to be inserted in the middle of a word or earlier in a string of words. In some implementations, the text insertion indicator includes a solid cursor, a blinking cursor, an arrow, a vertical line, a horizontal line, a colored indicator, any other suitable indicator, or any combination thereof. In an example, the text insertion indicator is a blinking vertical line similar in height to the computer generated characters. In another example, the text insertion indicator is an underline displayed under a particular selection of characters or words. In another example, the text insertion indicator is an arrow pointing at the place where the next character will be placed. In another example, the text insertion indicator is a colored or shaded area of a display screen. In some implementations, the character recognition application may display or hide text insertion indicator 416 based on the state of the application, the displayed content, user input, system settings, user preferences, user history, any other suitable parameters, or any combination thereof. In an example, the character recognition application may display a blinking cursor when preceded by a computer generated character, and may hide a cursor when preceded by a representation of a handwritten glyph. In some implementations, the character recognition application may control or alter blinking, color, animations, or other dynamic properties based on, for example, the system state in order to provide information to the user. For example, the system may change the color of the cursor when user input is required regarding a prior character or word. It will be understood that the aforementioned text insertion indicators and behaviors are merely exemplary and that any suitable indicator may be used. Further, in some implementations, a text insertion indicator may be omitted.

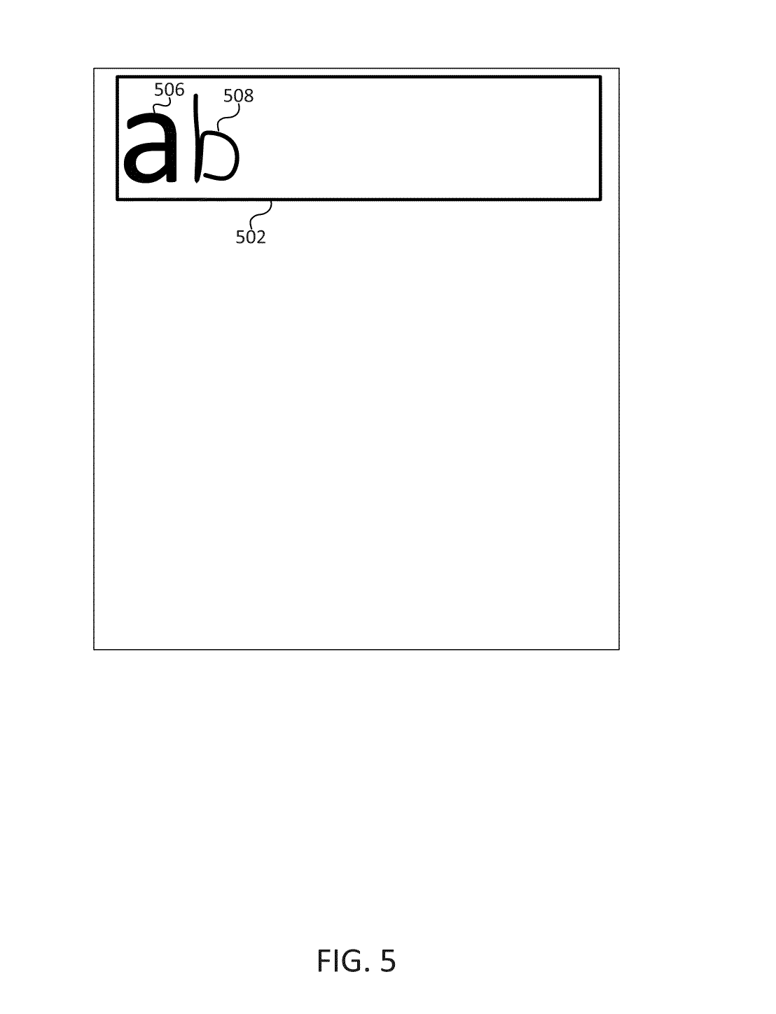

FIG. 5 is a further illustrative example of a character recognition application interface for recognizing and displaying text in accordance with some implementations of the present disclosure. The character recognition application may include display region 502. Display region 502 may include computer generated character “a” 506 and scaled representation “b” 508. The character recognition application may have received computer generated character “a” 506 from prior user input.

In an implementation, the character recognition application may generate scaled representation “b” 508 after receiving a handwritten glyph “b” in the handwritten glyph detection area of the display screen, as described in step 306 of FIG. 3. For example, the character recognition application may generate scaled representation “b” 508 using information from handwritten glyph “b” 406 of FIG. 4. The character recognition application may scale and rotate the representation as described in step 306 of FIG. 3. For example, where scaled representation “b” 508 relates to handwritten glyph “b” 406 of FIG. 4, it will be understood that handwritten glyph “b” 406 was rotated such that baseline 408 of FIG. 4 is substantially parallel with the bottom edge of display area 502. In some implementations, FIG. 5 includes a text insertion indicator as described for text insertion indicator 416 of FIG. 4. In the illustrated example, a text insertion indicator is hidden.

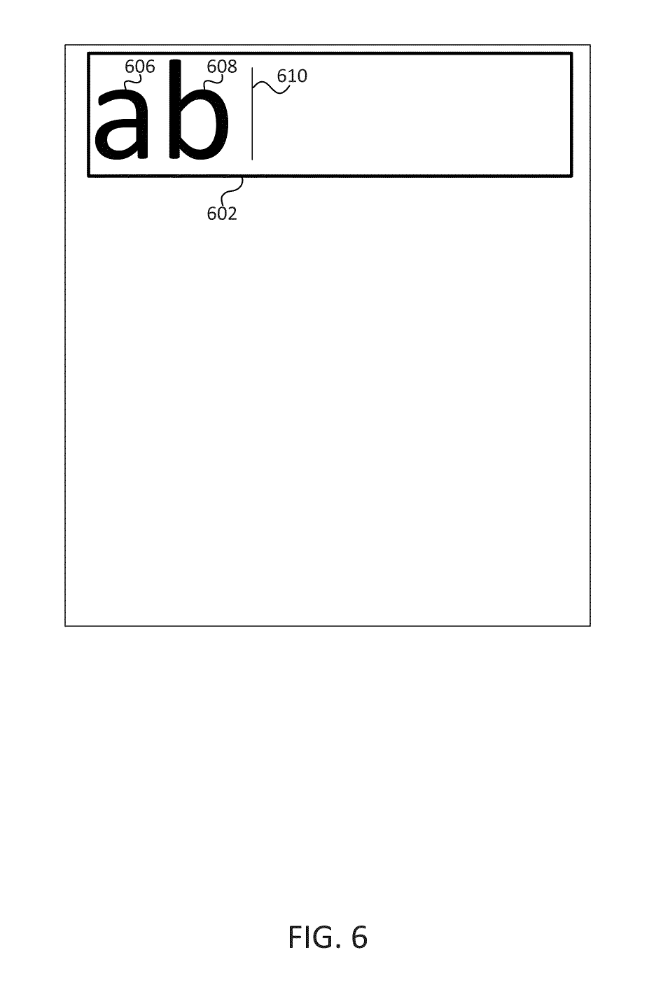

FIG. 6 is a further illustrative example of a character recognition application interface for recognizing and displaying text in accordance with some implementations of the present disclosure. The character recognition application may include display area 602, computer generated character “a” 606, and computer generated character “b” 608. In some implementations, the character recognition application may display computer generated character “b” 608 after communicating a representation of a handwritten glyph, e.g., handwritten glyph “b” 406 of FIG. 4, to a remote server, as described in step 310 of FIG. 3, and receiving a related computer generated character from the remote server, as described in step 312 of FIG. 3. The character recognition application may communicate with, for example, handwriting recognition server 114 of FIG. 1. In some implementations, the character recognition application may replace scaled representation “b” 508 of FIG. 5 with computer generated character “b” 608. In some implementations, FIG. 6 includes a text insertion indicator 610, which may be configured as described for text insertion indicator 416 of FIG. 4.

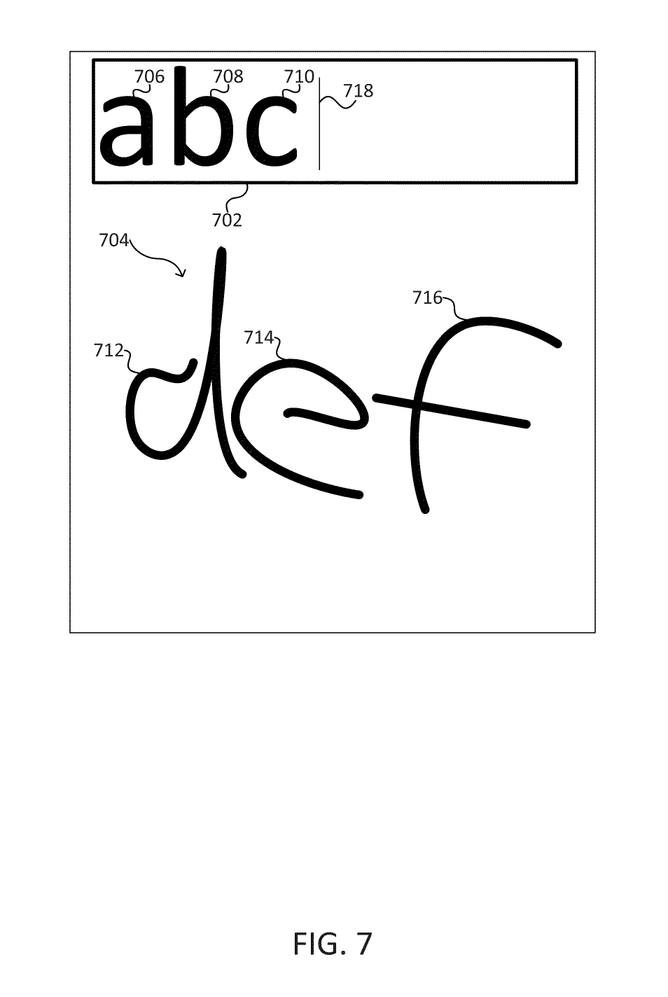

FIG. 7 is a further illustrative example of a character recognition application interface for recognizing and displaying text in accordance with some implementations of the present disclosure. The character recognition application may include display area 702 and handwritten glyph detection area 704. Display area 702 may include computer generated character “a” 706, computer generated character “b” 708, and computer generated character “c” 710. Handwritten glyph detection area 704 may include handwritten glyph “d” 712, handwritten glyph “e” 714, and handwritten glyph “f” 716. In some implementations, FIG. 7 includes a text insertion indicator 718, which may be configured as described for text insertion indicator 416 of FIG. 4.

In some implementations, the character recognition application may have received computer generated characters “a” 706, “b” 708, and “c” 710 from the remote server in response to communicating a representation of a handwritten glyphs, or from other prior input. The character recognition application may receive handwritten glyphs “d” 712, “e” 714, and “f” 716 in handwritten glyph detection area 704. For example, a touchscreen may receive input as described in step 302 of FIG. 3. The character recognition application may generate a representation of the traced paths as described in step 304 of FIG. 3. The character recognition application may display a representation of handwritten glyphs “d” 712, “e” 714, and “f” 716 on the display screen as they are received. The character recognition application may communicate the representation of handwritten glyphs “d” 712, “e” 714, and “f” 716 with the remote server, as described in step 310 of FIG. 3. It will be understood that the character recognition application may receive any number of handwritten glyphs, or other suitable input, substantially continuously or sequentially in handwritten glyph detection area 704.

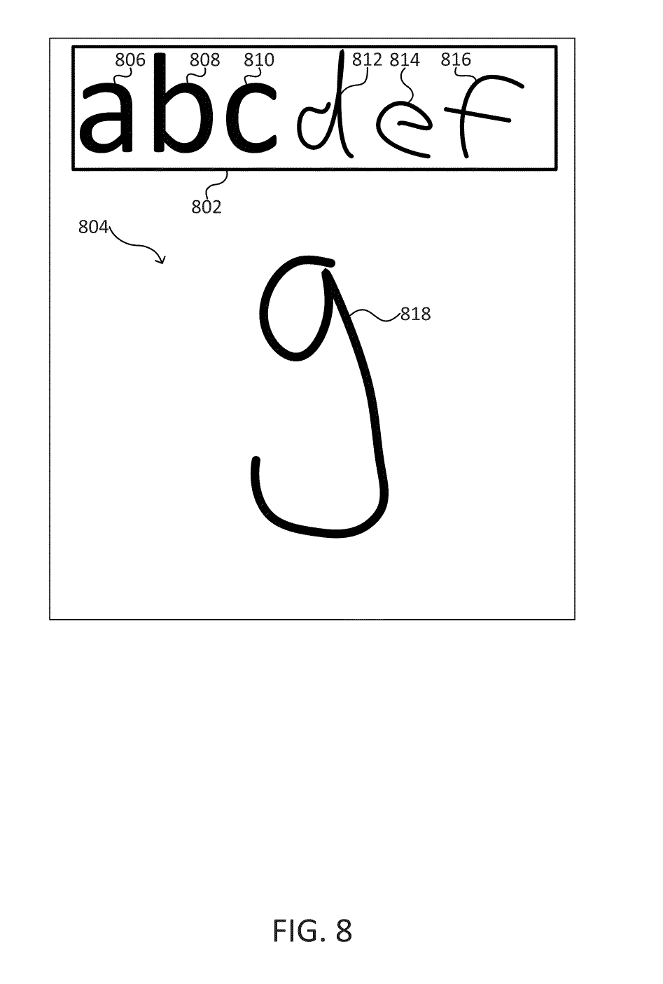

FIG. 8 is a further illustrative example of a character recognition application interface for recognizing and displaying text in accordance with some implementations of the present disclosure. The character recognition application may include display area 802 and handwritten glyph detection area 804. Display area 802 may include computer generated character “a” 806, computer generated character “b” 808, and computer generated character “c” 810. Display area 802 may include scaled representation “d” 812, scaled representation “e” 814, and scaled representation “f” 816. Handwritten glyph detection area 804 may include handwritten glyph “g” 818. In some implementations, FIG. 8 includes a text insertion indicator as described for text insertion indicator 416 of FIG. 4. In the illustrated example, a text insertion indicator is hidden.

In some implementations, the character recognition application may display scaled representations “d” 812, “e” 814, and “f” 816, as described in step 308 of FIG. 3, after they have been received as handwritten glyphs in handwritten glyph detection area 804, as described in step 302 of FIG. 3. For example, scaled representation “d” 812, “e” 814, and “f” 816 may be scaled representations of handwritten glyphs “d” 712, “e” 714, and “f” 716 of FIG. 7. The character recognition application may have scaled and rotated the representations prior to displaying the representations in display area 802, as described in step 306 of FIG. 3.

The character recognition application may receive handwritten glyph “g” 818 in handwritten glyph detection area 804. For example, a touchscreen may receive input from the finger or stylus of a user tracing the path indicated by handwritten glyph “g” 818, as described in step 302 of FIG. 3. The character recognition application may generate a representation of the traced path, as described in step 304 of FIG. 3. The character recognition application may display a representation of handwritten glyph “g” 818 on the display screen as it is received. The character recognition application may communicate the representation of handwritten glyph “g” 818 with a remote server, as described in step 310 of FIG. 3.

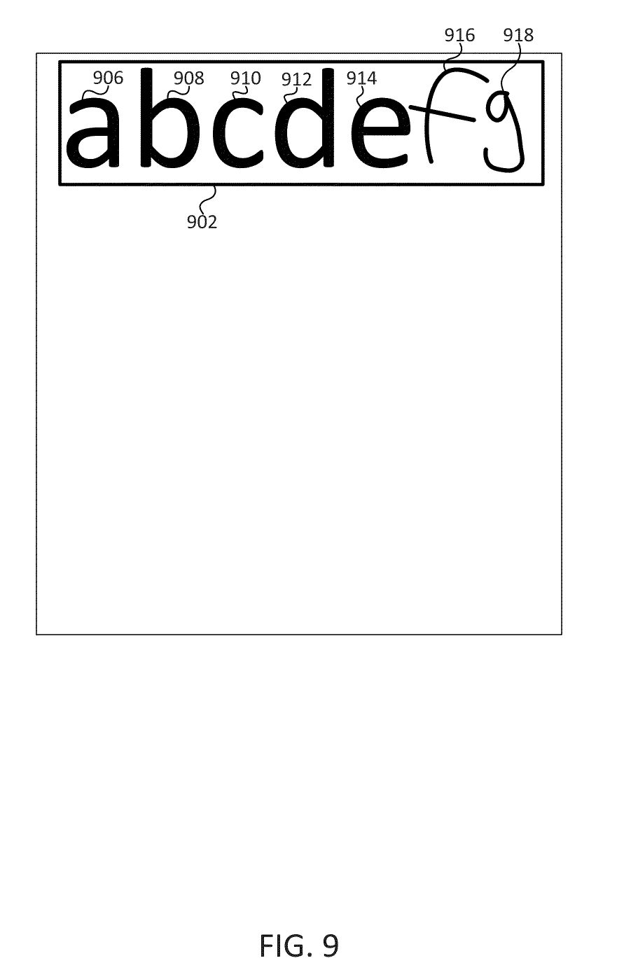

FIG. 9 is a further illustrative example of a character recognition application interface for recognizing and displaying text in accordance with some implementations of the present disclosure. The character recognition application may include display area 902. Display area 902 may include computer generated character “a” 906, computer generated character “b” 908, computer generated character “c” 910, computer generated character “d” 912, and computer generated character “e” 914. Display area 902 may include scaled representation “f” 916 and scaled representation “g” 918. In some implementations, FIG. 9 includes a text insertion indicator as described for text insertion indicator 416 of FIG. 4. In the illustrated example, a text insertion indicator is hidden.

In some implementations, the character recognition application may display computer generated characters “d” 912 and “e” 914 after communicating a representation of a handwritten glyph to a remote server and receiving a related computer generated character from the remote server. For example, the character recognition application may communicate representations of handwritten glyph “d” 712 of FIG. 7 and handwritten glyph “e” 714 of FIG. 7 to the remote server, and receive related computer generated character “d” 912 and computer generated character “e” 914 from the remote server.

In some implementations, the character recognition application may display scaled representation “f” 916 and scaled representation “g” 918 after they have been received as handwritten glyphs. For example, scaled representation “f” 916 and “g” 918 may be scaled representations of handwritten glyph “f” 716 of FIG. 7 and handwritten glyph “g” 818 of FIG. 8. The character recognition application may scale and rotate the representations prior to displaying the representations in display area 802, as described in step 306 of FIG. 3.

In some implementations, the character recognition application may receive computer generated characters in an order and grouping different from the order and grouping that was communicated to the remote server, as described for step 314 of FIG. 3. For example, representations of handwritten glyphs “d” 712, “e” 714, and “f” 716 of FIG. 7 may be communicated to the remote server at substantially the same time, and a representation of handwritten glyph “g” 818 of FIG. 8 may be communicated to the remote server after some delay. The character recognition application may receive computer generated character “d” 912, related to handwritten glyph “d” 712 of FIG. 7, and computer generated character “e” 914, related to handwritten glyph “e” 714 of FIG. 7, at the same time. The character recognition application may display computer generated characters “d” 912 and “e” 914 in display area 902, replacing, for example, scaled representations “d” 812 and “e” 814 of FIG. 8, as described in step 314 of FIG. 3. In the implementation illustrated in FIG. 9, the character recognition application may display computer generated characters “d” 912 and “e” 914 while displaying handwritten glyphs “f” 716 and “g” 818. In some implementations, the character recognition application may delay replacing scaled representations of handwritten glyphs in display area 902 with computer generated characters received from the remote server. For example, the character recognition application may delay replacing a representation of a handwritten glyph with a computer generated character until a particular amount of information has been received from the remote server, e.g., a predefined number of characters or completed words.

In some implementations, the character recognition application may replace a scaled representation of a character with a related computer generated character only if all preceding scaled representations have been replaced with computer generated characters. For example, given left-to-right text, the character recognition application may avoid displaying a scaled representation to the left of a computer generated character. In some implementations, the character recognition application may replace scaled representations with computer generated characters upon receipt from a remote server.

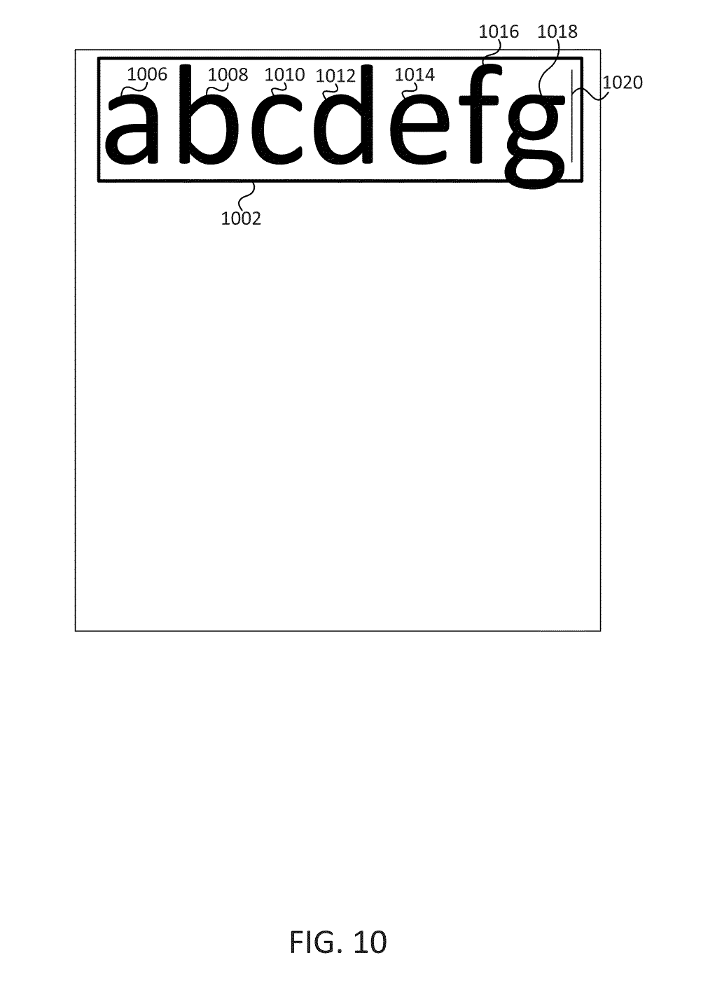

FIG. 10 is a further illustrative example of a character recognition application interface for recognizing and displaying text in accordance with some implementations of the present disclosure. The character recognition application may include display area 1002. Display area 1002 may include computer generated character “a” 1006, computer generated character “b” 1008, computer generated character “c” 1010, computer generated character “d” 1012, computer generated character “e” 1014, computer generated character “f” 1016, and computer generated character “g” 1018. In some implementations, FIG. 10 includes text insertion indicator 1020, which may be configured as described for text insertion indicator 416 of FIG. 4. The character recognition application may display computer generated characters in display area 1002 that it has received from a remote server in response to communicating representations of handwritten glyphs. For example, the character recognition application may receive computer generated character “f” 1016 and “g” 1018 in response to communicating a representation of handwritten glyph “f” such as handwritten glyph “f” 716 of FIG. 7, and handwritten glyph “g” such as handwritten glyph “g” 818 of FIG. 8, to the remote server. In a further example, the character recognition application may replace a scaled representation “f” such as scaled representation “f” 916 of FIG. 9, and a scaled representation “g” such as scaled representation “g” 918 of FIG. 9, with respective computer generated characters “f” 1016 and “g” 1018.

FIG. 11 is an illustrative example of a character recognition application interface for rescaling the representations of handwritten glyphs, in accordance with some implementations of the present disclosure. In some implementations, the character recognition application may scale representations of handwritten glyphs as described in step 306 of FIG. 3.

In some implementations, the character recognition application may display scaled representations of characters in display area 1102. The dimensions of the scaled representation may be based at least in part on the dimensions of the text box or of the display area. The character recognition application may display handwritten glyph “b” 1114 in display area 1102. Display area 1102 may include an outer bounding box 1112 and an inner bounding box 1104. The character recognition application may display outer bounding box 1112 and inner bounding box 1104, may hide outer bounding box 1112 and inner bounding box 1104, or any combination thereof. The size of inner bounding box 1104 may be adjusted according to predetermined parameters, remotely defined parameters, user set parameters, heuristically identified parameters, any other suitable parameters, or any combination thereof. In some implementations, the character recognition application may define the size of inner bounding box 1104 based in part on the dimensions of display area 1102. For example, the character recognition application may define outer bounding box 1112 as 100% of the dimensions of the display area, and may define inner bounding box 1104 as 80% of the dimensions of display area 1102.

In some implementations, the character recognition application may divide the representation of a handwritten glyph into any number segments. For example, the character recognition application may divide the path traced by handwritten glyph “b” 1114 into segments of equal length. The segments may be divided by markers such as marker 1110. Content based search application may not visibly display markers in display area 1102. The content based search application may scale handwritten glyph “b” 1114 such that a predetermined portion of the segments, as delineated by markers such as marker 1110, are contained by inner bounding box 1104. For example, the character recognition application may scale handwritten glyph “b” 1114 such that 80% of the segments are contained by inner bounding box 1104. For example, the character recognition application may consider segment 1106 to be outside of inner bounding box 1104 and segment 1108 to be inside of inner bounding box 1104. In some implementations, the character recognition application may scale character “b” 1114 such that a predefined portion of the markers, such as marker 1110, are contained by inner bounding box 1104. In some implementations, the character recognition application may scale character “b” 1114 such that a predefined portion of its path length is contained by inner bounding box 1104. In some implementations, the character recognition application may use the height of the glyph to determine scaling. In some implementations, the character recognition application may alter the height and width of a glyph independently. It will be understood that the rescaling methods described herein are merely illustrative any that any suitable technique for rescaling representations of characters to display in a display area may be used.

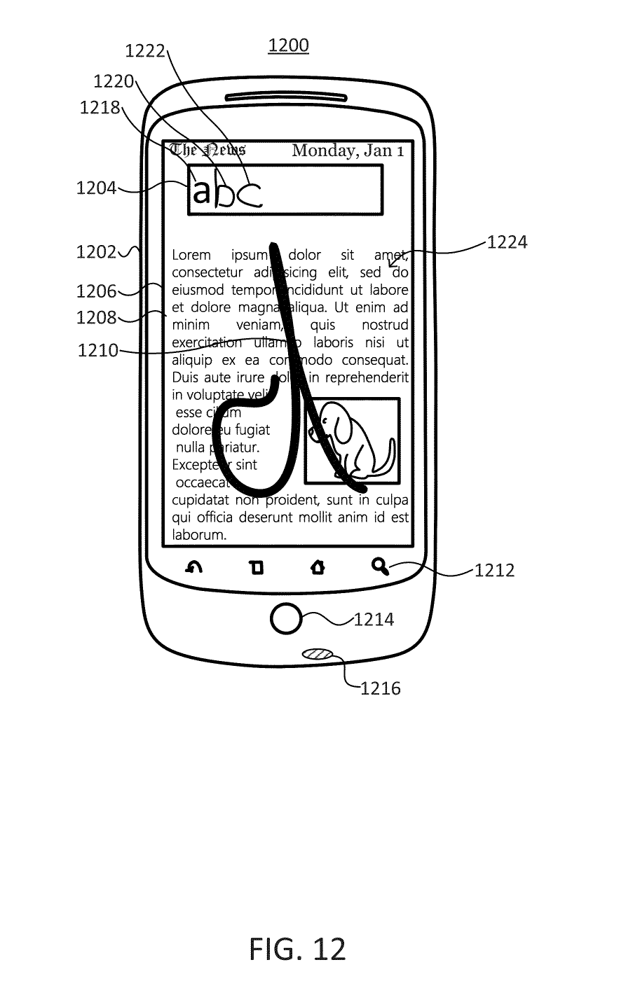

FIG. 12 is an illustrative smartphone device on which a character recognition application may be implemented in accordance with some implementations of the present disclosure. The character recognition application may be implemented on a user device such as smartphone 1200, a tablet, a desktop computer, a laptop computer, a gaming device, any other suitable computing equipment, or any combination thereof. The character recognition application may receive input from button 1214, softkey 1212, microphone 1216, touchscreen 1206, and other inputs not shown. The character recognition application may display content on display screen 1208. For example, the character recognition application may receive handwritten glyph “d” 1210 using touchscreen 1206. The character recognition application may use display screen 1208 to display a corresponding display element in substantially the same location as the handwritten glyph “d” 1210 was received. Display area 1204 may display computer generated characters, e.g., computer generated “a” 1218, and scaled representations of characters, e.g., scaled representations “b” 1220 and “c” 1222. In some implementations, the character recognition application may be triggered by activation of softkey 1212, activation of button 1214, or input to microphone 1216. In some implementations, the character recognition application may receive information to execute a search on smartphone 1200 such as, for example, a Google search of the internet. In some implementations, the character recognition application may receive information to compose an email, text message, or other document on smartphone 1200.

In some implementations, the character recognition application may use display area 1204 as a search box. The character recognition application may use the contents of the search box to execute a search. The character recognition application may communicate the computer generated characters contained within display area 1204 to a search engine server, for example, search engine server 122 of FIG. 1. In some implementations, the search may be executed using the computer generated characters recognized up to that point as a search query. The search query may be updated in real time as computer generated characters are identified from the representations of the handwritten glyphs. For example, the character recognition application may execute one or more searches using computer generated character “a” 1218 as a search query. If scaled representation “b” 1220 is replaced with a computer generated character “b,” the search query may be updated to “ab” in real-time with or without further user input. In some implementations, the character recognition application may predict one or more words based on the computer generated characters identified up to that point. The character recognition application may in part use the one or more predicted words to execute the one or more searches. In some implementations, the character recognition application may receive user input regarding search execution, e.g., refinement of the search query, desired search engine, where to display search results. In some implementations, the handwriting recognition server, such as handwriting recognition server 114 of FIG. 1, may communicate directly with the search engine server, communicate through a network, e.g., network 104 of FIG. 1, communicate through smartphone 1200, communicate by any other suitable pathway, or any combination thereof.

In some implementations, content 1224 may be displayed in the glyph detection region, in display area 1204, in any other suitable portion of display screen 1208, or any combination thereof. For example, content 1224 displayed on smartphone 1200 may be a webpage, as shown, an email, a homescreen, an application, any other suitable content, or any combination thereof. In some implementations, the character recognition application may be displayed in display screen 1208 overlayed on content 1224. The character recognition application may dim content 1224, cover content 1224, hide content 1224, use any other suitable technique for obscuring content 1224, or any combination thereof. In some implementations, the character recognition application may resize content 1224, move content 1224, use any other suitable technique to reconfigure content 1224, or any combination thereof, so that both the character recognition application and content 1224 are visible. It will be understood that any variation of obscuring, reconfiguring, overlaying, any other suitable technique, or any combination thereof, may be used to display both content 1224 and the character recognition application on the display screen.

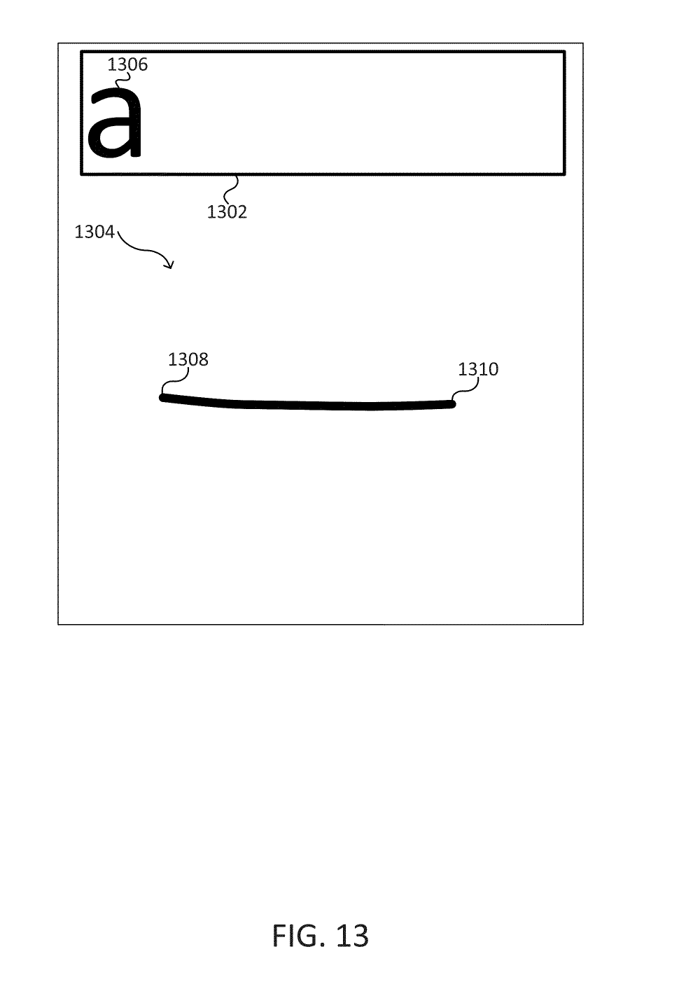

FIG. 13 is an illustrative example of a character recognition application interface for recognizing punctuation and control characters in accordance with some implementations of the present disclosure. In some implementations, the character recognition application may include display region 1302 and handwritten glyph detection area 1304. Display region 1302 may display computer generated character “a” 1306. The character recognition application may have information related to computer generated character “a” 1306 from a previously entered handwritten glyph, from a character entered using a keyboard, by any other suitable input method, or any combination thereof.

The character recognition application may receive a punctuation gesture such as a space, period, slash, any other punctuation, or any combination thereof. The character recognition application may receive control characters, for example, enter, tab, escape, delete, carriage return, any other suitable control character, or any combination thereof. In some implementations, the character recognition application may receive punctuation and control characters as predefined gestures. In some implementations, the character recognition application may recognize the predefined gestures using information acquired from a remote server, using information acquired by machine learning based on user input, using information acquired by user-set preferences, using information acquired by any other suitable technique, or any combination thereof.

In some implementations, a space character may be received as a substantially horizontal line drawn from left to right. For example, as illustrated in FIG. 13, the character recognition application may recognize a gesture drawn from gesture location 1308 to gesture location 1310 as a space character. In some implementations, a backspace control character may be received as a substantially horizontal line drawn from right to left. For example, the character recognition application may recognize a gesture drawn from gesture location 1310 to gesture location 1308 as a backspace control character.

In some implementations, the character recognition application may use any combination of pattern matching, heuristic searching, spell-check, grammar-check, any other suitable processing technique, or any combination thereof, to identify punctuation and control characters. For example, spaces may be automatically inserted between words following a spell-check to identify complete words. In another example, a diagonal gesture may be recognized as a forward slash character when it is part of a web URL.

The foregoing is merely illustrative of the principles of this disclosure and various modifications may be made by those skilled in the art without departing from the scope of this disclosure. The above described implementations are presented for purposes of illustration and not of limitation. The present disclosure also may take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

1. A computer-implemented method comprising:
receiving, by touch gesture input in a text input area of a presentation displayed by a device, an original representation of a handwritten glyph displayed in the text input area;
generating, using one or more computers, a scaled-down representation of the handwritten glyph including scaling the original representation of the handwritten glyph to a smaller size according to a size of a text display area of the display of the presentation, the text display area being different from and smaller in size than the text input area in which the touch gesture input was received;
responsive to generating the scaled down representation of the handwritten glyph and before receiving a recognized character corresponding to the touch gesture input from a character recognition service,
removing from display, in the text input area, the original representation of a handwritten glyph; and
providing, for display, in the text display area, the scaled-down representation of the handwritten glyph in the presentation as a next input character of the text input portion of the presentation;
responsive to receiving, from the character recognition service, a recognized character corresponding to the touch gesture input:
replacing, in the text display area, the scaled down representation of the handwritten glyph with the recognized character.

2. The method of claim 1, wherein the text input area encompasses the text display area.

3. The method of claim 1, wherein the touch gesture input is a user figure gesture input.

4. The method of claim 1, wherein the text input area in which the touch gesture input is received covers substantially all display area of the device.

5. The method of claim 1, wherein receiving the original representation of the handwritten glyph comprises receiving touch gesture input overlaid on content displayed in the presentation.

6. The method of claim 1, wherein the original representation of a handwritten glyph and the scaled down representation of the handwritten glyph are not displayed on the device concurrently.

7. The method of claim 1, wherein the character recognition service is provided by a remote server computer.

8. The method of claim 1, wherein the text display area of the presentation comprises a search box, the method further comprising repeatedly updating a search query in the text display area of the presentation based on each subsequent recognized character received from the character recognition service.

9. The method of claim 1, wherein the device is a smartphone device or a tablet computer.

10. A system comprising:
one or more computers and one or more storage devices storing instructions that are operable, when executed by the one or more computers, to cause the one or more computers to perform operations comprising:
receiving, by touch gesture input in a text input area of a presentation displayed by a device, an original representation of a handwritten glyph displayed in the text input area;
generating, using one or more computers, a scaled-down representation of the handwritten glyph including scaling the original representation of the handwritten glyph to a smaller size according to a size of a text display area of the display of the presentation, the text display area being different from and smaller in size than the text input area in which the touch gesture input was received;
responsive to generating the scaled down representation of the handwritten glyph and before receiving a recognized character corresponding to the touch gesture input from a character recognition service,
removing from display, in the text input area, the original representation of a handwritten glyph; and
providing, for display, in the text display area, the scaled-down representation of the handwritten glyph in the presentation as a next input character of the text input portion of the presentation;
responsive to receiving, from the character recognition service, a recognized character corresponding to the touch gesture input:
replacing, in the text display area, the scaled down representation of the handwritten glyph with the recognized character.

11. The system of claim 10, wherein the text input area encompasses the text display area.

12. The system of claim 10, wherein the touch gesture input is a user finger movement.

13. The system of claim 10, wherein receiving the original representation of the handwritten glyph comprises receiving touch gesture input overlaid on content displayed in the presentation.

14. The system of claim 10, wherein the original representation of a handwritten glyph and the scaled down representation of the handwritten glyph are not displayed on the device concurrently.

15. The system of claim 10, wherein the character recognition service is provided by a remote server computer.

16. The system of claim 10, wherein the text display area of the presentation comprises a search box, the method further comprising repeatedly updating a search query in the text display area of the presentation based on each subsequent recognized character received from the character recognition service.

17. The system of claim 10, wherein the device is a smartphone device or a tablet computer.

18. A computer program product, encoded on one or more non-transitory computer storage media, comprising instructions that when executed by one or more computers cause the one or more computers to perform operations comprising:
receiving, by touch gesture input in a text input area of a presentation displayed by a device, an original representation of a handwritten glyph displayed in the text input area;
generating, using one or more computers, a scaled-down representation of the handwritten glyph including scaling the original representation of the handwritten glyph to a smaller size according to a size of a text display area of the display of the presentation, the text display area being different from and smaller in size than the text input area in which the touch gesture input was received;
responsive to generating the scaled down representation of the handwritten glyph and before receiving a recognized character corresponding to the touch gesture input from a character recognition service,
removing from display, in the text input area, the original representation of a handwritten glyph; and
providing, for display, in the text display area, the scaled-down representation of the handwritten glyph in the presentation as a next input character of the text input portion of the presentation;
responsive to receiving, from the character recognition service, a recognized character corresponding to the touch gesture input:
replacing, in the text display area, the scaled down representation of the handwritten glyph with the recognized character.

19. The computer program product of claim 18, wherein the text input area encompasses the text display area.

20. The computer program product of claim 18, wherein the text input area in which the touch gesture input is received covers substantially all display area of the device.

21. The computer program product of claim 18, wherein receiving the original representation of the handwritten glyph comprises receiving touch gesture input overlaid on content displayed in the presentation.

22. The computer program product of claim 18, wherein the original representation of a handwritten glyph and the scaled down representation of the handwritten glyph are not displayed on the device concurrently.

23. The computer program product of claim 18, wherein the character recognition service is provided by a remote server computer.

24. The computer program product of claim 18, wherein the text display area of the presentation comprises a search box, the method further comprising repeatedly updating a search query in the text display area of the presentation based on each subsequent recognized character received from the character recognition service.

25. The computer program product of claim 18, wherein the device is a smartphone device or a tablet computer.
